(19) United States
(12) Patent Application Publication
(10) Pub. No.: US 2013/0256349 A1
(43) Pub. Date: Oct. 3, 2013

(54) TOOL TETHERS

(71) Applicants: Peter Hadwin Styth, Bratton (GB); Philip Waddingham, Sheffield (GB); Nicholas Marshall, Madeley (GB)

(72) Inventors: Peter Hadwin Styth, Bratton (GB); Philip Waddingham, Sheffield (GB); Nicholas Marshall, Madeley (GB)

(21) Appl. No.: 13/853,193

(22) Filed: Mar. 29, 2013

(30) Foreign Application Priority Data
Mar. 29, 2012 (GB) 1205541.4

(51) Int. Cl. A45F 5/00; B25H 3/00

(52) U.S. Cl. CPC A45F 5/00; B25H 3/00
USPC 224/271; 24/3.13; 29/428

(57) ABSTRACT

A tool tether (100) includes a plurality of strands (101) of flexible material, and a securing arrangement (104) for securing the plurality of strands in a loop.

The present invention relates to tool tethers and tools with tethers.

There is a significant risk of hand tools being dropped while working at height. A tool weighing 0.43 kg (1 lb) when dropped from a height of 9.14 m (30 feet) will reach an impact speed of 27.36 kph (17 mph). If the distance after impact is assumed to be 0.99 cm (0.39 inches) then the tool in question will exert a force of 1320 N or mass equivalent of 134.49 kg (296.5 lb). The extent of the damage caused depends on the orientation, shape, and the material from which the tool is made of. It can cause direct or indirect injury to the work force or civilians by landing on a person or by creating floor hazards on the level below.

Potential risks to the company using a tool that is dropped include sickness absences, risk of litigation, as well as damage to property, processing equipment or the tool itself. Not only are they hazards, but falling tools can also reduce productivity by time lost in retrieving the dropped tool. According to UK Health and Safety surveys, being struck by falling objects is the second most common cause of fatal accidents to the work force.

In order to address these issues, there needs to be an attachment point on the tool for attaching it to an anchor, e.g. via a lanyard. An effective attachment point must be permanent, durable, ergonomic, must not compromise the integrity of the tool and, most importantly, must not fail in the case of a drop. Lack of existing standards and guidelines (in the UK at least) regarding how a tool should be attached to a lanyard often means that improvised, inadequate methods of arresting are used. Alternatively, many tools are used without any preventative measures, which is clearly dangerous. Many tools used in industry today are not designed with a permanent attachment point suitable for a lanyard, and this is the reason why companies improvise. Improvised attachment points can often invalidate the tool manufacturer's warranty.

When improvising an attachment point often it has often been wrongly assumed that the force involved in a drop is given by the formula F=ma. This is only valid for calculating weight and fails to take into account the change in kinetic energy (F_{Ave}×d=KE_{Final}−KE_{Initial}=ΔKE).

Embodiments of the present invention are intended to address at least some of the abovementioned problems.

According to a first aspect of the present invention there is provided a tool tether including or comprising:

a plurality of strands of flexible material, and

a securing arrangement for securing the plurality of strands in a loop.

In use, the loop can be secured through an aperture in (or another loop on) a portion of a tool, typically a handle portion of the tool. The loop may be a single closed loop that can be generally circular or oval in shape.

The securing arrangement may comprise a tubular member that is compressed over portions including, or adjacent to, both ends of the plurality of strands, thereby forming and securing the loop. The securing arrangement may be formed of a deformable material/metal, e.g. aluminium. At least one further tubular member may be compressed adjacent to the first-mentioned tubular member. The tubular member may have an oval cross-section prior to the compression, and may have a generally circular cross-section following the compression. An inner diameter of the tubular member prior to the compression may be at least equal to a combined diameter of the strands. The tubular member may have dimensions selected from a set including: height: 7 mm, 8 mm or 9 mm; thickness: 1 mm, 1.2 mm, 1.5 mm; internal diameter: 2 mm, 2.5 mm, 3 mm.

The securing arrangement may surround at least a crossed-over portion of the strands. In some embodiments a portion including at least one said end of the strands protrudes out of the securing arrangement and in some embodiments portions including both ends of the strands protrude out of the securing arrangement.

The tether may further include a strand sheath that covers at least a portion of the strands. The sheath may be formed of flexible material, such as plastic, and may be of tubular form.

The tether may further include a securing arrangement sheath that covers at least a portion of the securing arrangement. The securing arrangement sheath may be formed of a flexible material, such as polyolefin, silicone, elastomeric, fluorinated ethylene propylene, polyvinylidene fluoride, fluoropolymer or polyvinyl chloride. The securing arrangement sheath may be fixed, e.g. by heat shrinking, onto the strand sheath.

The strands may be formed of galvanised steel. A said strand may have a diameter in a range of around 0.160 mm-0.330 mm. At least some of the strands may be woven/twisted together for strength. There may be around 5-10, and typically, 7 said strands in the tether. An embodiment of the tether may be intended for use with a tool weighing up to 1 kg, in which case a combined diameter of the strands may be around 1.5 mm. An embodiment of the tether may be intended for use with a tool weighing up to 1.5 kg, in which case a combined diameter of the strands may be around 2.0 mm. An embodiment of the tether may be intended for use with a tool weighing up to 2.5 kg, in which case a combined diameter of the strands may be around 2.5 mm.

In practice, the tethers can be batch tested and issued with a safety certificate. The tethers and/or the tethered tool can include a tracking device, e.g. an RFID.

According to another aspect of the present invention there is provided a tool including or comprising:

a portion including a bore or a loop;

a plurality of strands, and

a securing arrangement for securing the plurality of strands in a loop through the bore or the first mentioned loop.

The portion may include a handle portion. The portion may be located towards a tip of the handle.

The tool may be a hand tool. The tool may be powered.

A lanyard for fixing the tool/tether to a person may further be provided.

According to another aspect of the present invention there is provided a method of forming a tool tether, the method including:

forming a plurality of strands of flexible material into a loop;

securing the strands in the loop by fixing a securing arrangement over at least a crossed-over portion of the strands.

The loop may be passed through a bore in, or another loop on, a tool.

According to a further aspect of the present invention there is provided a method of testing a tool tether substantially as described herein.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

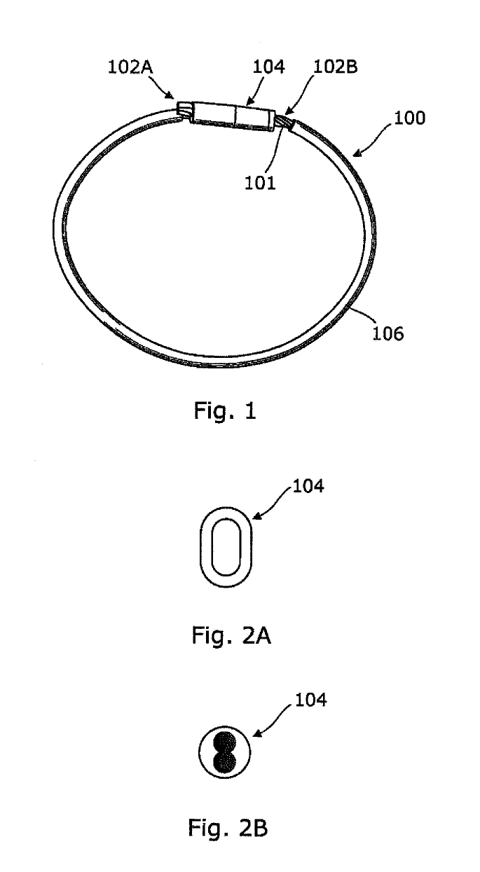

FIG. 1 is a plan view an example tether without a securing arrangement sheath;

FIG. 2A is an end view of a securing arrangement;

FIG. 2B is sectional view of the securing arrangement after it has been compressed around portions of strands;

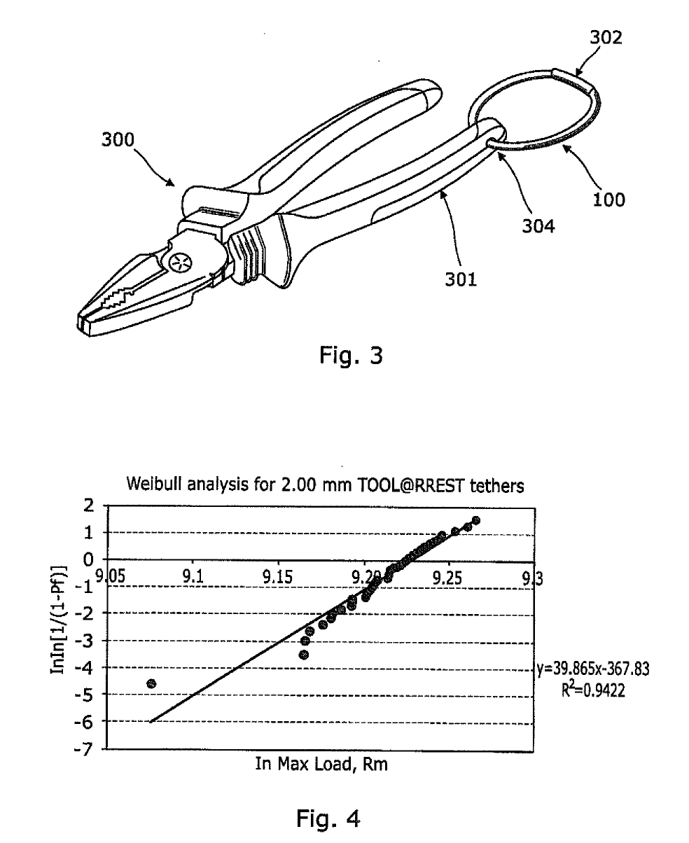

FIG. 3 shows an example tether attached to a tool, and

FIG. 4 is a graph illustrating an example of statistical analysis performed on a tether.

FIG. 1 shows an example tool tether 100. The tether formed from a plurality of strands, indicated generally at 101, at least some of which may be woven/twisted together for strength, that have been brought together to the form a generally circular loop. The strands in the example embodiment are a rope formed of galvanised steel, but it will be understood that other materials/structures, e.g. Mild steel, polymers, Kevlar, copper or stainless steel could be used, either alone or as a combined multiple. In alternative embodiments, the shape of the loop may be oval rather than circular.

The number and dimensions of the strands will depend on the weight of the tool with which the tether 100 is to be used. Each strand may have a diameter between around 0.16 mm-0.33 mm. Examples of preferred strand dimensions for tools of certain weights, as calculated by the present inventors, are given below:

| Weight of tool | Combined diameter of strands | Breaking Load |
|---|---|---|
| 1 kg | 1.5 mm | 8.29 kg |
| 2 kg | 2.0 mm | 11.06 kg |
| 2.5 kg | 2.5 mm | 13.82 kg |

The loop of the example tether 100 has a diameter of 8 cm, but in other embodiments, the diameter can be up to 12 cm. The combined cross-sectional thickness/diameter of the strands may be achieved in some cases by weaving/twisting around 5-10, and in one embodiment 7, strands of galvanised steel.

Below is a table (split in two) showing calculations performed by the inventors relating to the predicted results of the drop tests.

| Combined | | | | | | | Length |
|---|---|---|---|---|---|---|---|
| diameter | | | Cross- | | Length | Height | of |
| of | Weight | Diameter of | sectional area | | of the | of | the |
| strands | of tool | each strand | of strands | | tether | drop | lanyard |
| (m) | (kg) | (m) | (m²) | Modules (N/m²) | (m) | (m) | (m) |
| 0.0015 | 0.5 | 0.000166667 | 1.06847E−06 | 207,000,000,000 | 0.19 | 2 | 1.8 |
| 0.0015 | 1 | 0.000166667 | 1.06847E−06 | 207,000,000,000 | 0.19 | 2 | 1.8 |
| 0.0015 | 1.5 | 0.000166667 | 1.06847E−06 | 207,000,000,000 | 0.19 | 2 | 1.8 |
| 0.0015 | 2 | 0.000166667 | 1.06847E−06 | 207,000,000,000 | 0.19 | 2 | 1.8 |
| 0.0015 | 2.5 | 0.000166667 | 1.06847E−06 | 207,000,000,000 | 0.19 | 2 | 1.8 |
| 0.0015 | 3 | 0.000166667 | 1.06847E−06 | 207,000,000,000 | 0.19 | 2 | 1.8 |
| 0.0015 | 3.5 | 0.000166667 | 1.06847E−06 | 207,000,000,000 | 0.19 | 2 | 1.8 |
| 0.0015 | 4 | 0.000166667 | 1.06847E−06 | 207,000,000,000 | 0.19 | 2 | 1.8 |
| 0.0015 | 4.5 | 0.000166667 | 1.06847E−06 | 207,000,000,000 | 0.19 | 2 | 1.8 |
| 0.0015 | 5 | 0.000166667 | 1.06847E−06 | 207,000,000,000 | 0.19 | 2 | 1.8 |
| 0.0015 | 5.5 | 0.000166667 | 1.06847E−06 | 207,000,000,000 | 0.19 | 2 | 1.8 |
| 0.0015 | 6 | 0.000166667 | 1.06847E−06 | 207,000,000,000 | 0.19 | 2 | 1.8 |
| 0.0015 | 6.5 | 0.000166667 | 1.06847E−06 | 207,000,000,000 | 0.19 | 2 | 1.8 |
| 0.0015 | 7 | 0.000166667 | 1.06847E−06 | 207,000,000,000 | 0.19 | 2 | 1.8 |
| 0.0015 | 7.5 | 0.000166667 | 1.06847E−06 | 207,000,000,000 | 0.19 | 2 | 1.8 |
| 0.0015 | 8 | 0.000166667 | 1.06847E−06 | 207,000,000,000 | 0.19 | 2 | 1.8 |
| 0.0015 | 8.5 | 0.000166667 | 1.06847E−06 | 207,000,000,000 | 0.19 | 2 | 1.8 |
| 0.0015 | 9 | 0.000166667 | 1.06847E−06 | 207,000,000,000 | 0.19 | 2 | 1.8 |
| 0.0015 | 9.5 | 0.000166667 | 1.06847E−06 | 207,000,000,000 | 0.19 | 2 | 1.8 |
| 0.0015 | 10 | 0.000166667 | 1.06847E−06 | 207,000,000,000 | 0.19 | 2 | 1.8 |
| 0.0015 | 10.5 | 0.000166667 | 1.06847E−06 | 207,000,000,000 | 0.19 | 2 | 1.8 |
| 0.0015 | 11 | 0.000166667 | 1.06847E−06 | 207,000,000,000 | 0.19 | 2 | 1.8 |
| 0.0015 | 11.5 | 0.000166667 | 1.06847E−06 | 207,000,000,000 | 0.19 | 2 | 1.8 |
| 0.0015 | 12 | 0.000166667 | 1.06847E−06 | 207,000,000,000 | 0.19 | 2 | 1.8 |
| 0.0015 | 12.5 | 0.000166667 | 1.06847E−06 | 207,000,000,000 | 0.19 | 2 | 1.8 |

| Length | | | | | | |
|---|---|---|---|---|---|---|
| of | F/A | | | | | |
| tether | (Force/ | | | | | |
| and | Cross | | | | Force | Force/Mass |
| lanyard | sectional | | | (F/A) * (((2AE/F) + | approximation | approximate |
| (m) | Area) | 2AE | 2AE/F | 1)\hat{ }0.5) + 1) | (N) | (kg) |
| 2 | 4590667 | 442347.5 | 4.905 | 1.383E+09 | 1477.908 | 150.6532 |
| 2 | 9181334 | 442347.5 | 4.905 | 2.766E+09 | 2955.816 | 301.3065 |
| 2 | 13772001 | 442347.5 | 4.905 | 4.15E+09 | 4433.725 | 451.9597 |
| 2 | 18362667 | 442347.5 | 4.905 | 5.533E+09 | 5911.633 | 602.6129 |
| 2 | 22953334 | 442347.5 | 4.905 | 6.916E+09 | 7389.541 | 753.2662 |
| 2 | 27544001 | 442347.5 | 4.905 | 8.299E+09 | 8867.449 | 903.9194 |
| 2 | 32134668 | 442347.5 | 4.905 | 9.682E+09 | 10345.36 | 1054.573 |
| 2 | 36725335 | 442347.5 | 4.905 | 1.107E+10 | 11823.27 | 1205.226 |
| 2 | 41316002 | 442347.5 | 4.905 | 1.245E+10 | 13301.17 | 1355.879 |
| 2 | 45906668 | 442347.5 | 4.905 | 1.383E+10 | 14779.08 | 1506.532 |
| 2 | 50497335 | 442347.5 | 4.905 | 1.522E+10 | 16256.99 | 1657.186 |
| 2 | 55088002 | 442347.5 | 4.905 | 1.66E+10 | 17734.9 | 1807.839 |
| 2 | 59678669 | 442347.5 | 4.905 | 1.798E+10 | 19212.81 | 1958.492 |
| 2 | 64269336 | 442347.5 | 4.905 | 1.936E+10 | 20690.72 | 2109.145 |
| 2 | 68860003 | 442347.5 | 4.905 | 2.075E+10 | 22168.62 | 2259.799 |
| 2 | 73450669 | 442347.5 | 4.905 | 2.213E+10 | 23646.53 | 2410.452 |
| 2 | 78041336 | 442347.5 | 4.905 | 2.351E+10 | 25124.44 | 2561.105 |
| 2 | 82632003 | 442347.5 | 4.905 | 2.49E+10 | 26602.35 | 2711.758 |
| 2 | 87222670 | 442347.5 | 4.905 | 2.628E+10 | 28080.26 | 2862.411 |
| 2 | 91813337 | 442347.5 | 4.905 | 2.766E+10 | 29558.16 | 3013.065 |
| 2 | 96404004 | 442347.5 | 4.905 | 2.905E+10 | 31036.07 | 3163.718 |
| 2 | 1.01E+08 | 442347.5 | 4.905 | 3.043E+10 | 32513.98 | 3314.371 |
| 2 | 1.06E+08 | 442347.5 | 4.905 | 3.181E+10 | 33991.89 | 3465.024 |
| 2 | 1.1E+08 | 442347.5 | 4.905 | 3.32E+10 | 35469.8 | 3615.678 |
| 2 | 1.15E+08 | 442347.5 | 4.905 | 3.458E+10 | 36947.71 | 3766.331 |

The table above relates to a tether having a diameter of 1.5 mm, but it will be understood that similar information can be derived for tethers having other diameters, e.g. 1.0, 2.0, 2.5, 3.0, 3.5, 4.5, 4.5 mm. These figures were used by the present inventors to produce guidelines for testing each tether category. The data gathered was analysed to produce the relevant probability of failure for each tether type in the category. This data corresponds to the maximum stress the tether could possibly endure:
Tensile test to destruction without any tools attached or dropped.
Tethered to the heaviest tool from its category and destroyed without any drops.
Tethered to the heaviest tool in its category. The tether must be dropped a minimum 50 times.
For the tools with manufactured attachment points, the tether was also be tested by
   D shackling to calibrated weights equivalent to heaviest tool in its category allowed for the tether in its category according to a prediction chart based on statistical records of the likelihood of various types of industrial accidents (e.g. slips, trips or falls on the same level; struck by a moving/falling object; injured whilst handling, carrying of lifting; falls from a height; falls and slips combined, etc).
   Dropped a minimum 50 times using fall factor 2 attached to a rope with no dampening effect ensuring maximum stress has been transferred to the tether.
   Tensile tested to destruction.

The type of data needed for this testing can include:
Sample population large enough to allow the data to be used in a statistical analysis to produce a probability of failure being zero in a million. This is intended to comply with official standards (e.g. Weibull analysis: BS EN 61649:2008).
The probability of failure calculated above is considered invalid and must be recalculated if there are any changes to:
   The place of the attachment.
   Change in the tether design.
   Change in the material used.
   Change in the manufacturing process.
   Change in manufacturing technique.
   Change in manufacturing equipment.

The probability of failure was calculated for each and every individual test condition and with every tether category. The values were then cross referenced to draw a picture of each change to the testing parameters as to the failure rate of the tether. The probability of failure was intended not to be larger than 0.00000003 (±0.000000005) in 10⁶. This should detect if the tether is being affected by each test condition. Once the data was collected for each category of tethers, the failure probability was cross referenced to explore if any of the test conditions showed an abnormality affecting the probability of failure (zero in one in a million). If the above value was not achieved then that category of the tether/product was not used. Further investigation, redesign, re-manufacture can be required and the necessary changes implemented. The new range then can only be reintroduced after being re-tested in line with the testing regimes and only when the above statistics have been achieved for each and every test condition.

The strands are held together in the loop formation by means of a securing arrangement 104. In the example, the securing arrangement comprises a tubular member/ferrule that is compressed over at least a crossed-over portion of the strands. During manufacture, first 102A and second 102B ends of the strand are passed through the tubular member, crossing each other within it, with portions (of around 1-3 mm in length) of the ends protruding out of the respective ends of the tubular member. A sheath 106 covers the majority of the exposed portion of the strands, generally up to the ends of the securing arrangement 106. This sheath can be formed of tubular, flexible material, such as polyolefin, silicone, elastomeric, fluorinated ethylene propylene, polyvinylidene fluoride, fluoropolymer or polyvinyl chloride.

FIG. 2A is an end view of the example tubular member 104 before the strands are passed through it. The member is oval in cross-section-please and the table below gives dimensions for various categories of tethers:

| Size | Height | Thickness | Internal Diameter |
|---|---|---|---|
| Of Tubular | Of Tubular | Of Tubular | Of Tubular |
| Member | Member | Member | Member |
| 2.0 mm | 7.0 mm | 1.0 mm | 2.0 mm |
| 2.5 mm | 8.0 mm | 1.2 mm | 2.5 mm |
| 3.0 mm | 9.0 mm | 1.5 mm | 3.0 mm |

The tubular member 104 will normally be formed of strong, deformable material, such as aluminium. After the strands have been passed through it, it is compressed and a sectional view of the result is shown in FIG. 2B. The member has been compressed so that it is generally circular in cross-section, with a diameter of around. The compression force is typically around 5 Tonnes in both axes and typically employs a compression machine. In the illustrated orientation (which corresponds to a sectional end view through part of the tether 100 including the securing arrangement when it is resting on a flat horizontal surface, although it will be understood that orientation can vary during manufacture/use), a first portion of the strands is positioned above/adjacent a second portion of the strands, giving a figure-of-eight outline. It will be appreciated that the design and dimensions of the securing member can vary, e.g. in other embodiments it may have a circular, square or irregular cross-sectional shape before being compressed

FIG. 3 shows the tether 100 connected to a tool 300. The tether in this Figure includes an outer sheath 302 that covers the securing arrangement 104, the ends 102A, 1028 of the strands and has both its ends fixed to portions of the strands sheath 106 either side of the securing arrangement. This outer sheath can be formed of tubular, flexible material, such as polyolefin, silicone, elastomeric, fluorinated ethylene propylene, polyvinylidene fluoride, fluoropolymer or polyvinyl chloride, and can be fixed to the tether by means of heat shrinking. A company/product logo or other information may be present (e.g. by means of printing) on this sheath. A lanyard (not shown) for fixing the tool/tether to a person (e.g. to a tool belt or the like) may further be provided.

The tether 100 is connected to the tool 300 by means of passing through a bore 304 formed in a portion of the tool. The tool in the illustrated example is a pair of pliers and the bore is formed towards the tip of one of its handles 301. The bore will have a diameter slightly greater than the portion of the tether that does not include the securing arrangement. However, it will be appreciated that the manner of attachment between the tether and the tool can be varied. For example, the bore may be located elsewhere on the tool, or a loop, shackle or the like can be fixed to a portion of the tool, with the tether being attached to that. The tether can be attached to the tool during manufacture, or can be retro-fitted to tools without suitable connection means. Although a set of pliers are shown in the Figure, it will be appreciated that the tether can be used with a wide variety of tools, including powered tools, such as drills and saws.

The inventors also developed a rigorous testing regime, including drop and tensile testing, for testing the tethers. These test results were then used to continuously improve and maximize the safety of the tethers by performing a Weibull analysis on the test results. FIG. 4 shows an example of one of the statistical analysis performed on a 2 mm diameter tether in order to drive the Weibull modules. This was performed on each tether type with a sample population of 50. The results are used to drive a probability of failure and safety factors for each tether type. The testing regime itself was also reviewed regularly to maintain its relevance to each tool's application. The testing regime can involve the following:
The tool (having a maximum weight in its weight category) incorporating the tether was drop tested N times and then tensile tested to destruction.
The tether was D-shackled to an equivalent categorised weight, drop tested N times and then tensile tested to destruction.
The tool incorporating the tether was tensile tested N times. The tether was tested to destruction N times.
The tether D-shackled to an equivalent categorised weight was tested to destruction N times.

The inventors calculated that N=50 provided an excellent testing regime, but it will be understood that the number can vary. The testing procedures and the construction of the tethers (including the type of materials used, the number and thicknesses of the strands, and the use of the sheath(s)) described herein could be considered to be over-engineered according to conventional engineering practice. However, the inventors overcame this technical prejudice and determined that tethers that satisfied requirements that go above and beyond those of conventional safety tethers are beneficial in terms of safety and peace of mind for customers/users. In practice, the tethers can be batch tested and issued with a safety certificate. The tethers/tools can incorporate microchip technology, e.g. RFID tags, in order to make them traceable for after care maintenance.

The tethers described herein can enhance a tool's performance without compromising its integrity.

1. A tool tether (100) including:
a plurality of strands (101) of flexible material, and
a securing arrangement (104) for securing the plurality of strands in a loop.

2. A tether according to claim 1, wherein, in use, the loop is secured through a bore (304) in (or another loop on) a portion (301) of a tool (300).

3. A tether according to claim 1, wherein the loop is a single closed loop that is generally circular or oval in shape.

4. A tether according to claim 1, wherein the securing arrangement (104) comprises a tubular member that is compressed over portions including, or adjacent to, both ends (102A, 102B) of the plurality of strands (101), thereby forming and securing the loop.

5. A tether according to claim 4, wherein the securing arrangement (104) is formed of a deformable material/metal.

6. A tether according to claim 5, wherein the securing arrangement (104) is formed of aluminium.

7. A tether according to claim 4, wherein the tubular member (104) has an oval cross-section prior to the compression and a generally circular cross-section following the compression.

8. A tether according to claim 7, wherein an inner diameter of the tubular member prior to the compression is at least equal to the diameter of the strands (101).

9. A tether according to claim 8, wherein the tubular member (104) has dimensions selected from a set including: height: 7 mm, 8 mm or 9 mm; thickness: 1 mm, 1.2 mm, 1.5 mm; internal diameter: 2 mm, 2.5 mm, 3 mm.

10. A tether according to claim 1, wherein the securing arrangement (104) surrounds at least a crossed-over portion of the strands (101).

11. A tether according to claim 10, wherein a portion including at least one end (102A) of the strands (101) protrudes out of the securing arrangement (104).

12. A tether according to claim 11, wherein portions including both ends (102A, 102B) of the strands (101) protrude out of the securing arrangement (104).

13. A tether according to claim 1, further including a strand sheath (106) that covers at least a portion of the strands (101).

14. A tether according to claim 13, wherein the strand sheath (106) is formed of flexible material, such as polyolefin, silicone, elastomeric, fluorinated ethylene propylene, polyvinylidene fluoride, fluoropolymer or polyvinyl chloride, and is of tubular form.

15. A tether according to claim 1, further including a securing arrangement sheath (302) that covers at least a portion of the securing arrangement (104).

16. A tether according to claim 16, wherein the securing arrangement sheath (302) is formed of a flexible material, such as polyolefin, silicone, elastomeric, fluorinated ethylene propylene, polyvinylidene fluoride, fluoropolymer or polyvinyl chloride.

17. A tether according to claim 16, when dependent upon claim 13, wherein the securing arrangement sheath (302) is be fixed by heat shrinking onto the strand sheath (106).

18. A tether according to claim 1, wherein the strands (101) are formed of galvanised steel, mild steel, polymers, Kevlar, copper and/or stainless steel.

19. A tether according to claim 18, wherein a said strand has a diameter in a range of 0.160 mm-0.330 mm.

20. A tether according to claim 18, wherein at least some of the strands (101) are woven/twisted together for strength.

21. A tether according to claim 18, including 5-10 said strands (101).

22. A tether according to claim 21, including 7 said strands (101).

23. A tether according to claim 18, wherein the tether (100) is intended for use with a tool (300) weighing up to 1 kg, and wherein a combined diameter of the strands (101) is around 1.5 mm.

24. A tether according to claim 18, wherein the tether (100) is be intended for use with a tool (300) weighing up to 1.5 kg, and wherein a combined diameter of the strands (101) is around 2.0 mm.

25. A tether according to claim 18, wherein the tether (100) is intended for use with a tool (300) weighing up to 2.5 kg, and wherein a combined diameter of the strands (101) is around 2.5 mm.

26. A tether according to claim 18, wherein the tether (100) includes a tracking device, e.g. an RFID.

27. A tool (300) including:
a portion (301) including a bore (304) or a loop; and
a tether (100) including plurality of strands (101) and a securing arrangement (104) for securing the plurality of strands in a loop through the bore or the first mentioned loop.

28. A tool according claim 27, wherein the tool portion includes a handle portion (301).

29. A tool according to claim 28, wherein the portion is located towards a tip of the handle (301).

30. A tool according to claim 27, wherein the tool (300) comprises a hand tool.

31. A tool according to claim 27, wherein the tool (300) comprises a powered tool.

32. A tool according to claim 27, further including a lanyard for, in use, fixing the tool (300)/tether (100) to a person.

33. A method of forming a tool tether (100), the method including:
forming a plurality of strands (101) of flexible material into a loop;
securing the strands in the loop by fixing a securing arrangement (104) over at least a crossed-over portion of the strands.

34. A method according to claim 33, wherein the strands (101) are passed through a bore (304) in, or another loop on, a tool (300) before being formed into the loop.
